(19) United States
(12) Patent Application Publication
(10) Pub. No.: US 2022/0413502 A1
(43) Pub. Date: Dec. 29, 2022

(54) METHOD, APPARATUS, AND SYSTEM FOR BIASING A MACHINE LEARNING MODEL TOWARD POTENTIAL RISKS FOR CONTROLLING A VEHICLE OR ROBOT

(71) Applicant: HERE Global B.V., Eindhoven (NL)

(72) Inventor: Tero Juhani KESKI-VALKAMA, Zürich (CH)

(21) Appl. No.: 17/358,764

(22) Filed: Jun. 25, 2021

(51) Int. Cl. G05D 1/02; G06N 20/00; G05D 1/00

(52) U.S. Cl. CPC G05D 1/0214; G05D 1/0219; G05D 1/0221; G06N 20/00; G05D 1/0088; G05D 2201/0213

(57) ABSTRACT

An approach is provided for biasing machine learning models towards potential risks for controlling vehicles/robots. The approach involves, for example, determining an occluded space that is occluded in sensor data collected from one or more sensors of a vehicle or a robot. The approach also involves generating a sensor space completion that represents the occluded space based on biasing a generation of one or more potential risks to the vehicle or the robot originating from the occluded space. The approach further involves providing the sensor space completion to a system of the vehicle or the robot for generating a control decision, a warning, or a combination thereof.

### BACKGROUND

Autonomous control of a vehicle or other robotic system historically relies on sensing the environment in which the vehicle or robot is operating. However, because this sensing is often performed using sensors onboard the vehicle or robot, the sensed environmental state is generally incomplete because of occlusions due to obstructions in the line-of-sight of the sensors. Consequently, service providers face significant technical challenges to predicting the risks to the vehicle or robot that may originate from these occluded areas to provide for improved autonomous operation of the vehicle or robot.

### SOME EXAMPLE EMBODIMENTS

Therefore, there is a need for a machine learning approach that biases a machine learning model towards potential risks when predicting occluded portions of an environment state (e.g., for controlling a vehicle or robot or providing an automated warning about potential risks).

According to one embodiment, a method comprises determining an occluded space that is occluded in sensor data collected from one or more sensors of a vehicle or a robot. The method also comprises generating a sensor space completion that represents the occluded space based on biasing a generation of one or more potential risks to the vehicle or the robot originating from the occluded space. The method further comprises providing the sensor space completion to a system of the vehicle or the robot for generating a control decision, a warning, or a combination thereof.

According to another embodiment, an apparatus comprises at least one processor, and at least one memory including computer program code for one or more computer programs, the at least one memory and the computer program code configured to, with the at least one processor, cause, at least in part, the apparatus to determine an occluded space that is occluded in sensor data collected from one or more sensors of a vehicle or a robot. The apparatus is also caused to generate a sensor space completion that represents the occluded space based on biasing a generation of one or more potential risks to the vehicle or the robot originating from the occluded space. The apparatus is further caused to provide the sensor space completion to a system of the vehicle or the robot for generating a control decision, a warning, or a combination thereof.

According to another embodiment, a non-transitory computer-readable storage medium carries one or more sequences of one or more instructions which, when executed by one or more processors, cause, at least in part, an apparatus to determine an occluded space that is occluded in sensor data collected from one or more sensors of a vehicle or a robot. The apparatus is also caused to generate a sensor space completion that represents the occluded space based on biasing a generation of one or more potential risks to the vehicle or the robot originating from the occluded space. The apparatus is further caused to provide the sensor space completion to a system of the vehicle or the robot for generating a control decision, a warning, or a combination thereof.

According to another embodiment, an apparatus comprises means for determining an occluded space that is occluded in sensor data collected from one or more sensors of a vehicle or a robot. The apparatus also comprises means for generating a sensor space completion that represents the occluded space based on biasing a generation of one or more potential risks to the vehicle or the robot originating from the occluded space. The apparatus further comprises means for providing the sensor space completion to a system of the vehicle or the robot for generating a control decision, a warning, or a combination thereof.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of biasing a machine learning model toward potential risks, according to an example embodiment;

FIG. 2 is a diagram of components of a control module and/or control platform capable of biasing a machine learning model toward potential risks, according to an example embodiment;

FIG. 3 a flowchart of a process for biasing a machine learning model toward potential risk, according to an example embodiment;

FIGS. 4A and 4B are diagrams illustrating an example sensor environment with occluded spaces, according to an example embodiment;

FIG. 5A is flowchart of a process for training a machine learning model using biased data, according to an example embodiment;

FIG. 5B is a flowchart of a process or training a machine learning model using a risk score, according to an example embodiment;

FIG. 6 is a diagram illustrating an example of making a vehicle control decision and generating a warning message based on a machine learning model biased toward potential risk, according to an example embodiment;

FIG. 7 is a diagram of a geographic database, according to an example embodiment;

FIG. 8 is a diagram of hardware that can be used to implement an example embodiment;

FIG. 9 is a diagram of a chip set that can be used to implement an example embodiment; and

FIG. 10 is a diagram of a mobile terminal that can be used to implement an example embodiment.

### DESCRIPTION OF SOME EMBODIMENTS

Examples of a method, apparatus, and computer program for biasing a machine learning toward potential risks are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

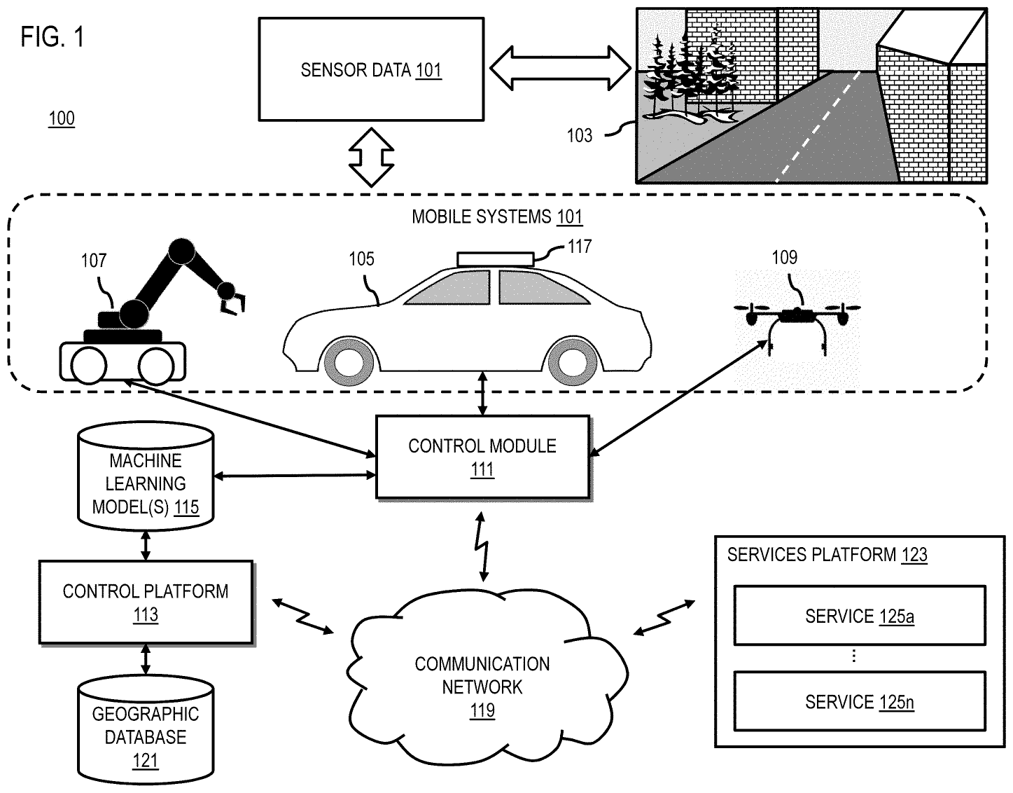

FIG. 1 is a diagram of a system 100 capable of biasing a machine learning model toward potential risks, according to an example embodiment. The various example embodiments described herein relate to autonomous control of mobile systems 101, e.g., when moving or traveling within a physical environment 103 (e.g., on a road network or other equivalent location). As used herein, mobile systems 101 refer to any device capable of moving, traveling, or otherwise operating in an environment 103. Examples of mobile systems 101 include but are not limited to: vehicles 105 (e.g., autonomous cars or equivalent), robots 107 (or any other type of terrestrial drone), aerial drones 109 (e.g., unmanned aerial vehicles), and/or equivalent. In one embodiment, these mobile systems 101 can be operated in autonomous or semi-autonomous using machine learning model-based control mechanisms (e.g., control module 111 and/or control platform 113). These mechanisms can employ, for instance, one or more machine learning models 115 (or equivalent processes) to make operational decisions on what actions (e.g., speed and/or direction of movements, turns, etc.) a mobile system 101 (e.g., autonomous mobile system 101) is to perform in a given environment 103.

By way of example, in model-based control, generative machine learning models such as, but not limited to, conditional Generative Adversarial Networks (GANs) can be used to create hypothetical, plausible futures given the control decisions, so that a separate optimizing control system can choose a sequence of control actions which produce the best possible results by running and re-running the trained machine learning model 115 through different alternative sequences of control actions and expected environment state corresponding to the physical environment 103 in which the mobile system 101 is operating.

However, the environment state is generally incompletely observed by the mobile system 101 (e.g., observed by one or more sensors 117—e.g., cameras, LiDAR, etc.—of the vehicle 105 or other mobile system 101), and may include noise and occlusions. Occluded parts include, for example, volumes or spaces behind visual obstructions for cameras and LiDAR and other sensors 117 such that sensor data is not available or otherwise of degraded quality (e.g., degraded below a threshold value or other quality criterion) for the volumes behind the obstructions. Other examples of sensor occlusions can be dependent on the type of sensor being used. For example, for LiDAR sensors, the angles and time durations which fall in-between the measured values may result in occlusions for which no sensor data is available. In yet another example, sensor data occlusions can occur based on directions in the environment 103 that are not observed by the sensors 117 (e.g., directions that are outside of the field of view or coverage range of a sensor 117). The occluded parts of the environment model are typically implicitly completed by the most plausible state of things, which means that even if the completion is not explicit, the trained model implicitly expects that the events and objects in the unobserved, occluded parts are minimally surprising. Completion, for instance, refers to predicting the events and/or objects that are in the unobserved, occluded parts of the environment.

Model-based control widely used in autonomous driving, industrial machinery, and other fields utilizes a machine-learned model of the world dynamics which is conditioned by the system control actions. This model (e.g., a conditional GAN) can be trained either using historical data or online data during the operation of the system. These conventional models historically model the most likely state of the world. Moreover, if they explicitly fill out occlusions in their observed sensor data and modeled environment state, they use most likely completions given what is known. However, the occlusions historically have not been completed, except in an implicit sense, in that the system is “aware” of the occlusion in terms of missing information but makes decisions as if this unknown state of the environment is minimally surprising.

Convention machine learning control models generally predict the environment in minimally biased fashion. For example, if it is rarely the case that a deer happens to jump from behind a bush to the road, a conventional machine learning system learns to not expect that. This means that the conventional system will likely implicitly or explicitly predict that there is no deer in a volume occluded by the bush and for which no sensor data is available or observed. Thus, in an example autonomous vehicle control example use case, the conventional system will not prepare for that potentiality in driving style or its vehicle control decisions.

In other words, conventional machine learning control generally controls the vehicles 105 or other mobile systems 101 in the model of the environment which represents the most likely state of the matter (e.g., a state based solely on previous observations in historical data). This means that conventional models may not adequately weigh up the potential states of the environment which represent significant physical danger to the vehicle 105 and its occupants, or to any other equivalent mobile system 101 (e.g., to meet target safety thresholds).

In practice, for instance, if it is rare that a bicyclist zooms onto the road from behind a corner of a building, a conventional machine learning control system learns to not assume that rare event and drives as if that event is not expected to happen. As a result, only statistically significant number of actual collisions caused by bicyclists zooming from behind that corner would cause a machine learning model controlling an autonomous vehicle to take that possibility into account and slow down accordingly. This would require a prohibitive number of bicyclist mortalities.

Thus, providers and manufacturers of autonomous control systems (e.g., control module 111 and/or control platform 113) face significant technical challenges with respect to generating or predicting completions of volumetric spaces that are occluded from the sensors 117 of mobile systems 101.

To address these technical challenges, the system 100 of FIG. 1 introduces a capability to bias machine learning models 115 (e.g., generative models) of unseen sensor space completions so that potentially hazardous events in the hidden or occluded regions are used to make control decisions for mobile system 101 (e.g., vehicles 105, robots 107, drones 109, etc.). The various embodiments described herein relate to mechanisms for training a machine learning model 115 which is biased towards intentionally unrealistic but possible dangers that may arise from unobserved occluded spaces. This means, for instance, that the control system (e.g., control module 111 and/or control platform 113) in effect expects a danger to arise from occluded volumes (e.g., by assuming a “deer behind every bush”), and thus decides to drive or operate a vehicle 105 or other mobile system 101 more carefully (e.g., by reducing speed, taking an alternate route, changing lanes, etc.).

In context of the control of autonomous vehicles 105, the prediction of what danger or other event that potentially could happen in an unseen space is becoming more critical as the speed of the self-driving vehicles 105 increases and the control decisions should not only take into account what is actually visible, but what could happen in the unseen space. The advantage of the various embodiments of this approach is that autonomous vehicles 105, robots 107, and/or any other type of mobile system 101 can learn to drive or operate carefully (e.g., within target levels of safety) in the presence of lots of obstructions which might hide dangerous scenarios and are unobserved by their respective sensors 117.

In summary, according to one embodiment, generative machine learning models 115 can be used to predict hidden phenomena in the unseen space caused by sensor occlusions. For example, a conditional GAN model 115 or similar can generate a representation of an occluded, volumetric space behind an obstruction that limits sensor visibility or coverage (e.g., a bush on the side of the road) with plausible completions in, e.g., 3D volumetric space. In one embodiment, the completions include predictions or generation of potential dangers or other events that originate from an unobserved volumetric space in the environment 103 and that can affect the operation or safety of a mobile system 101. In the various embodiments described herein, the system 100 considers the biases the most likely completions toward completions which represent the most risk. In effect, as previously discussed, the machine learning system (e.g., embodiments of control module 111 and/or control platform 113 in combination with machine learning models 115 as described herein) is biased towards generating completions that contain dangers or similar events based on risk and safety as opposed to just the observed rate of occurrence of the danger or event (e.g., expect a deer behind every bush), even though in reality that is not realistic (e.g., not representative of actual observed or recorded occurrences).

In one embodiment, this bias towards predicting dangers based on risk to complete occluded volumes naturally biases the control decisions made by autonomous control systems (e.g., self-driving systems of vehicles 105 and/or other mobile systems 101) to drive or operate carefully in environments 103 where there are lots of obstructions of view. For example, they system 100 can include one or more control modules 111 equipped locally in respective mobile systems 101 (e.g., vehicle 105) and/or one or more control platforms 113 operating on the server side (e.g., a cloud-based component) to perform the various embodiments described herein. By way of example, the control module 111 and/or control platforms 113 may communicate with each other and components of the system 100 over a communication network 119. These components can include but are not limited to: (1) a geographic database 121 that stores map data to facilitate navigating within the environment 103; and (2) a services platform 123 comprising one or more services 125a-125n (also collectively referred to as services 125) to provide related data (e.g., weather data, traffic data, etc.) that, for instance, can also be used as input features for generating sensor data completions according to the various embodiments described herein.

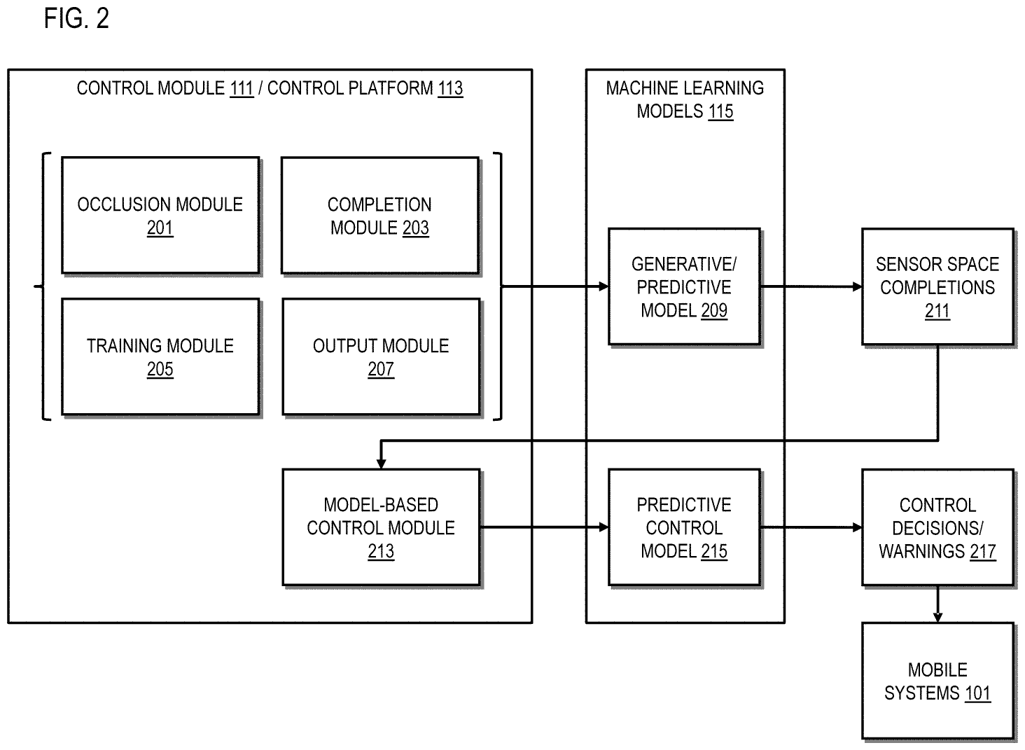

FIG. 2 is a diagram of components of a control module 111 and/or control platform 113 capable of biasing a machine learning model 115 toward potential risks, according to an example embodiment. As shown in FIG. 2, the control module 111 and/or control platform 113 include components for biasing a machine learning model to perform sensor data completion according to the various embodiments described herein. It is contemplated that the functions of the components of the control module 111 and/or control platform 113 may be combined or performed by other components of equivalent functionality. In one embodiment, the control module 111 and/or control platform 113 include: (1) a first set of a modules comprising an occlusion module 201, a completion module 203, training module 205, and an output module 207 for training and using a generative/predictive model 209 to generate sensor space completions 211; and (2) a model-based control module 213 that uses a predictive control machine learning model 215 (or equivalent) for generating control decisions/warnings 217 based on sensor space completions 211 generated by the modules 201-207 for output to mobile systems 101.

The above presented modules and components of the control module 111 and/or control platform 113 can be implemented in hardware, firmware, software, or a combination thereof. Though depicted as separate entities in FIG. 1, it is contemplated that the control module 111 and/or control platform 113 may be implemented as a module of any of the components of the system 100 (e.g., a component of the mobile system 101, vehicle 105, robot 107, drone 109, services platform 123, services 125, and/or the like). In another embodiment, one or more of the components 201-217 may be implemented as a cloud-based service, local service, native application, or combination thereof. The functions of the control module 111 and/or control platform 113 and components 201-217 are discussed in more detail below.

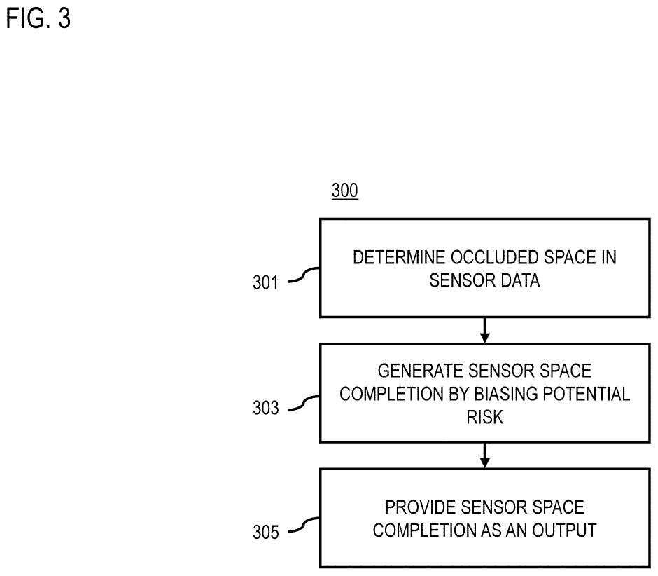

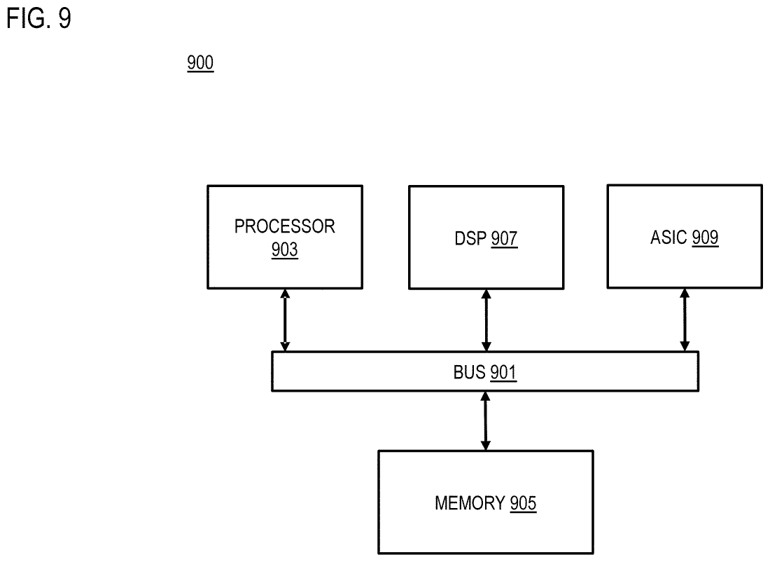

FIG. 3 a flowchart of a process for biasing a machine learning model 115 toward potential risk, according to an example embodiment. In various embodiments, the control module 111, control platform 113, and/or any of the components 201-217 may perform one or more portions of the process 400 and may be implemented in, for instance, a chip set including a processor and a memory as shown in FIG. 9. As such, the control module 111, control platform 113, and/or any of the components 201-217 can provide means for accomplishing various parts of the process 300, as well as means for accomplishing embodiments of other processes described herein in conjunction with other components of the system 100. Although the process 300 is illustrated and described as a sequence of steps, it is contemplated that various embodiments of the process 300 may be performed in any order or combination and need not include all of the illustrated steps.

In one embodiment, the process 300 relates to facilitating the operation or movement (e.g., autonomous operation or movement) of a mobile system 101 (e.g., vehicle 105, robot 107, drone 109, and/or equivalent) within a physical environment 103. As an input to the process 300, a mobile system 101 can include one or more sensors 117 (e.g., cameras, LiDAR, radar, location sensors, vehicle telemetry sensors, etc.) for detecting the state of the environment 103. The environment state, for instance, can represent objects or features present in the environment 103, locations of the objects, movements of the objects, characteristics of the objects, and/or any other related data that are indicative of the objects or features. In the example use case of a deer as discussed above, the environment state can include a detection of the deer, its location, its movement (e.g., speed and direction of travel), its size, etc. In one embodiment, the objects or features represented in the environment state can include any object or feature that are classified as a potential risk to the operation, physical integrity, safety, etc. of the mobile system 101 as it operates or travels in the environment 103.

In one embodiment, at least one component or sub-system of the mobile system 101 includes a model-based system (e.g., the model-based control module 213) for generating control decisions, warnings, or a combination thereof based on the state of the environment 103 in which it is operating. For example, if a deer is detected (e.g., via a camera of a vehicle 105), the vehicle 105 can automatically slow down (e.g., when operating in autonomous mode in response to control decisions 217 made by the model-based control module 213) to reduce the potential for a collision with the detected deer and/or to reduce the potential damage that can result from a collision with the deer or other potential danger. In addition or alternatively, the model-based control module 213 or equivalent system can present a warning or alert to the driver, passenger, or other operator of the mobile system 101 indicating the detected presence of the potential danger.

However, in some cases as discussed above, the sensors 117 may not have a complete view of the entire environment 103 because of occlusions or other obstructions in their fields of view, limited detection ranges, etc. Accordingly, in step 301 of process 300, the occlusion module 201 determines an occluded space that is occluded in sensor data collected from one or more sensors 117 of a mobile system 101 (e.g., vehicle 105, robot 107, drone 109, and/or equivalent). By way of example, the occluded space represents any volumetric or 3D space in the environment 103 that is hidden from the coverage area of the one or more sensors 117 of a mobile system 101 or for which sensor data that meets a threshold level of quality is not available.

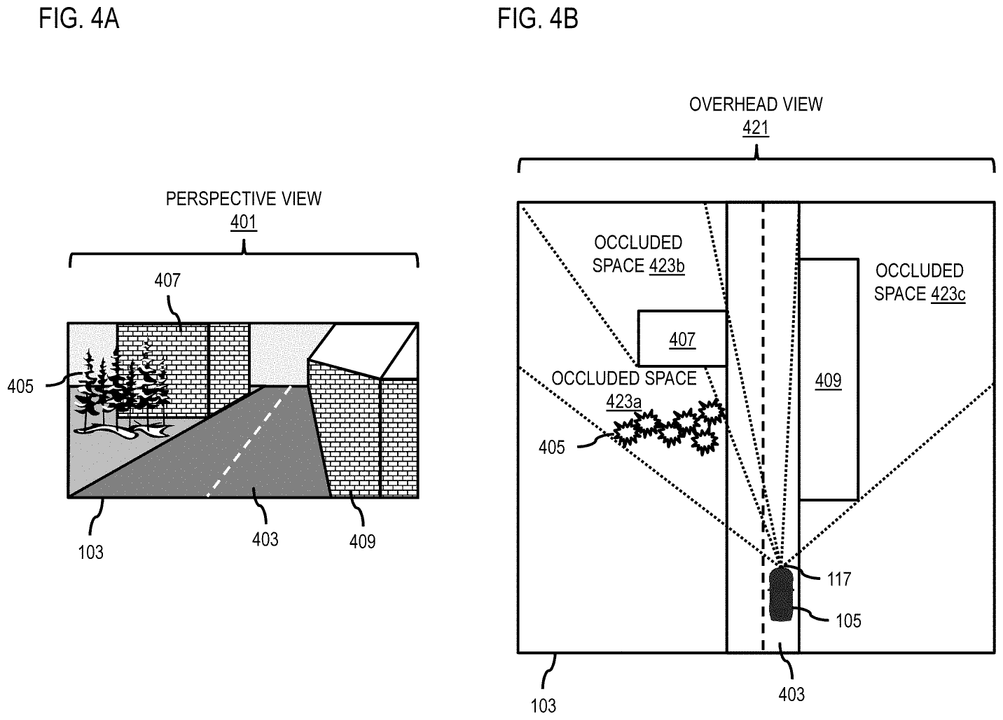

FIGS. 4A and 4B are diagrams illustrating an example sensor or physical environment 103 with occluded spaces, according to an example embodiment. More specifically, FIG. 4A illustrates a perspective view 401 of the example environment 103 from the point of view of a vehicle 105 traveling on the road 403 depicted in the perspective view 401. In this example, other objects in the environment 103 include trees 405, a first building 407 on the left side of the road 403 behind the trees 405, and a second building 409 on the right side of the road 403. The spatial arrangement of the objects in the environment 103 creates occlusions with respect to the sensor data collected from one or more sensors 117 equipped on the vehicle.

In other words, the objects 405-409 block the view of vehicle sensors 117 from obtaining a complete scan of the environment. FIG. 4B illustrates the environment 103 of FIG. 4A from an overhead view 421 to more clearly illustrate the occluded spaces 423a-423c (also collectively referred to as occluded spaces 423) created by the trees 405 and buildings 407 and 409. In the example of FIG. 4B, dash lines originating from a sensor 117 of the vehicle 105 represent the various lines of sight from the sensor 117 to respective edges of the occluding objects 405-409 present in the environment 103. For example, an occluded space 423a is created in the volumetric space traced by the lines of sight from the sensor 117 to the edges of the trees 405; an occluding space 423b is created in the volumetric space traced by the lines of sight from the sensor to the edges of the first building 407; and an occluded space 423c is created in the volumetric space traced by the lines of sight from the sensor 117 to the edges of the second building 409.

In one embodiment, the occluded spaces 423a-423c can be determined by processing the sensor data (e.g., camera images, LiDAR point meshes, Radar images, etc.) to identify distances and locations of the various detected objects 405-409 to determine their spatial arrangements and/or sight lines from the vehicle sensor 117. This processing can be performed by, e.g., using computer vision systems, object recognition systems, feature detectors, and/or any other equivalent processes.

The characteristics of the occluded spaces 423 can also vary with the types of objects creating the occlusion. For example, the occluded space 423a created by the occluding trees 405 may have at least some sensor data coverage depending on the nature and density of the foliage of the trees 405. In this case, a camera sensor 117 may still be able to capture fragmented images of objects at the are in the occluded space 423a but with degraded quality. To evaluate the degraded quality of the sensor data, the system 100 can be configured with any sensor data quality threshold or criteria for classifying whether the sensor data available for an occluded space 423 (if any) is degraded to a point where the space 423 should be considered occluded for performing sensor data completion according to the various embodiments described herein.

In other cases, such as with buildings 407 and 409, the occluding objects can be complete blocks to collecting sensor data, and thus there will be no sensor data associated with the respective occluded spaces 423b and 423c. Accordingly, the lack of any sensor data or sensor data readings above a threshold number can be used to identify the occluded spaces 423b and 423c. It is noted that the example embodiments described above for determining occluded spaces 423 in sensor data collected from an environment 103 are provided by way of illustration and not as limitations. It is contemplated that the various embodiments of the process 300 described herein can use any equivalent means for determining that volumetric space is an occluded space with respect to vehicle sensors 117 (i.e., a space for which no sensor data is available for determining the environment state within that volumetric space).

In step 303, after determining the occluded spaces 423 within the environment 103, the completion module 203 generates a sensor space completion that represents the occluded space 423 based on biasing a generation of one or more potential risks or dangers to a mobile system 101 (e.g., vehicle 105, robot 107, drone 109, etc.) originating from the occluded space 423. As used herein, a “sensor space completion” represents a predicted or machine generated representation of the environment state in the occluded space 423. The term “biasing,” for instance, refers to increasing the prevalence or probability of a potential risk or danger to be included in a sensor space completion over the actual or observed prevalence or probability of the potential risk or danger in data sampled from the environment 103 or other equivalent environment state data source.

In one embodiment, the sensor space completion is generated using a machine learning model (e.g., generative/predictive model 209). Accordingly, the biasing of the generation of the one or more potential risks comprises training the machine learning model using training data including an amount of example risk elements (e.g., examples of the potential risk or danger to a mobile system 101) greater than a proportional amount observed in the environment 103. By way of example, the proportional amount is determined based on the number of actual observed risk/danger events over all observed events in the environment. For example, the risk of encountering a danger such as a deer running into the road in front of a vehicle 105 may be 1 in 2,000 trip events on the road. Biasing, this risk would then comprise increasing the probability of encountering the deer from the observed 1 in 2,000 trip events to a higher target probability (e.g., 1 in 4 trip events, 1 in 2 trip events, etc.) depending on the target level of safety-influenced control behavior for the mobile system 101.

To train a model (e.g., generative/predictive model 209) for sensor space completions according to the embodiments described herein, the training module 205 can be configured with definitions of what dangerous or potential risk means. For example, the training module 205 can label and evaluate a risk score in the collected training sensor data for all regions of perception (e.g., all types of sensor data—camera, LiDAR, radar, etc.—collected by or otherwise associated with mobile systems 101 that are indicative of an environment state). Then, in the sensor space completion phase, the completion module 203 can score the sensor space completions representing the most risk accordingly.

In summary, by using training data (e.g., collected sensor data) which is annotated with risk scores, the training module 205 can train a system (e.g., a system comprising the generative/predictive model 209) to perform sensor space completions of occluded regions of environment models to produce high-risk scenarios instead of the minimally biased most likely, most realistic scenarios produced by conventional systems.

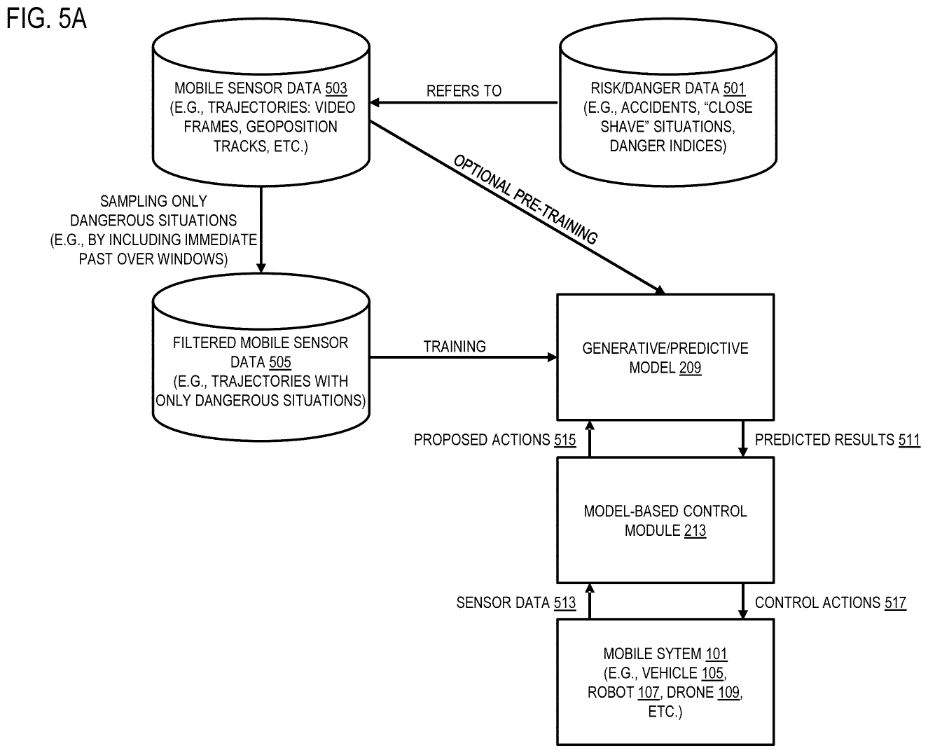

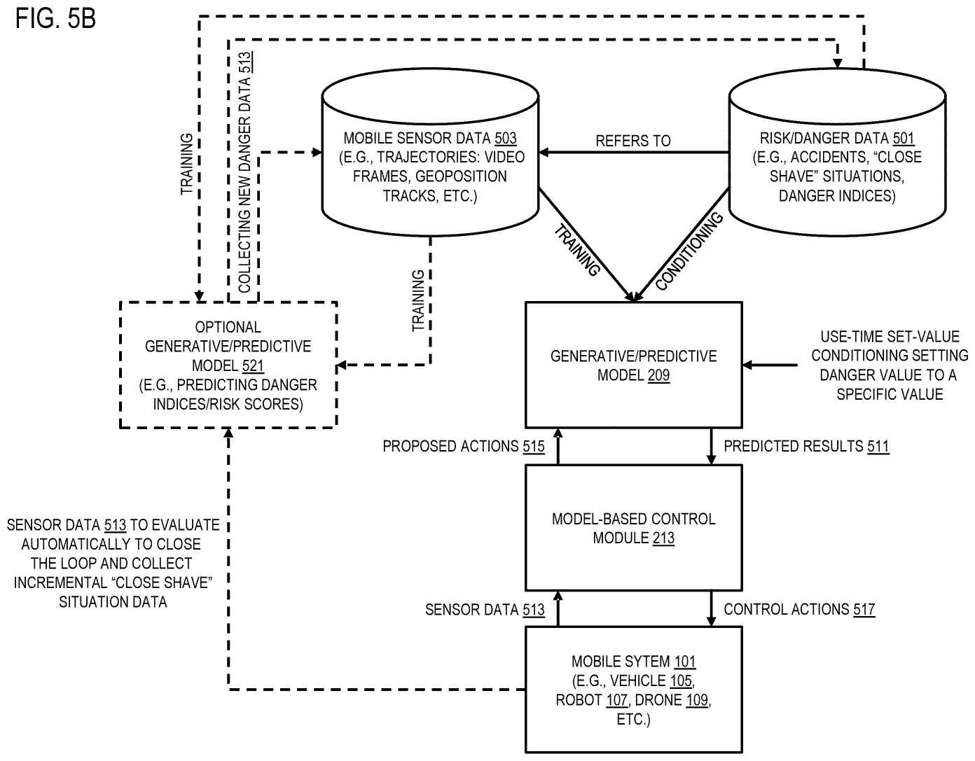

In one embodiment, the training module 205 can train the generative/predictive model 209 to bias potential risks using any biasing mechanism including, but not limited to:
1. Training a generative model 209 on data which is already biased, weighted or selected to include disproportional amount of examples of potential risks or dangers. For example, these examples of potential risks or dangers can include sensor data collected in situations where to risks or dangers (e.g., collisions, accidents, etc.) have manifested or nearly manifested (e.g., collisions or accidents that were just barely avoided—as determined by a human or machine classifier) or which have definitive risk elements. Various embodiments of this option are discussed in more detail with respect to FIG. 5A below.
2. Training the models so that the risk score is given as a conditional input to a generative model 209 to learn and associate the risk score of the situation to the data, so that when used in generative mode for model-based control it can be given a high target value for prediction risk, thus making the model create more risky futures. Various embodiments of this option are discussed in more detail with respect to FIG. 5B below.

In one embodiment, the generative/predictive model 209 is a conditional GAN that can generate sensor space completions based on conditions and attribute representing classes of potential risks or dangers (e.g., other vehicles, objects, animals, people, etc. that can collide with a mobile system 101 in the environment 103). A conditional GAN, for instance, includes a generator neural network (e.g., for generating sensor completions) and a discriminator neural network (e.g., for evaluating whether the generate sensor completions accurately represents a real environment state). Both the generator and discriminator networks can be provided with conditioning inputs (e.g., feature vectors) that indicate the class of the risk/danger objects and/or their properties to be included in the sensor completions. In addition, both the generator and discriminator of the conditional GAN can be trained to bias potential risks/dangers when generating sensor space completions according to the embodiments described herein. For example, the discriminator can be trained to classify whether a sensor space completion is “real” (e.g., represents an environment state according to a loss function) or “fake” (e.g., does not represent an environment state according to a loss function). The generator can then be trained to generate sensor space completions that the discriminator would classify as real. Once is the generator is able to cause the discriminator to classify its synthetic sensor space completions as real greater than a threshold rate, the training process can either end if a target level of performance is achieved or can recursively continue until the performance target is met. This recursive process, for instance, retrains the discriminator with additional data (e.g., including sensor completions produced by the generator that fooled the discriminator) to improve its ability to distinguish between real and artificial sensor space completions. The improved discriminator is then used to improve the training of the generator to generate more realistic or accurate sensor space completions (e.g., completions that reflect the conditioning features or attributes).

It is noted that the example of a conditional GAN is provided by way of illustration and not as a limitation. It is contemplated that the system 100 can employ any equivalent generative/predictive model, algorithm, or process to generate sensor space completions according to the embodiments described herein. Examples of other models include but are not limited to a recurrent model, an auto-encoder, a predictive supervised model, or equivalent.

FIG. 5A describes a first model training option and is flowchart of a process for training a machine learning model (e.g., generative/predictive model 209) using biased data, according to an example embodiment. As previously discussed, sensor space completions are generated using a machine learning model (e.g., a generative/predictive model 209 such as a conditional GAN). In one embodiment, the biasing of the generation of the one or more potential risks for sensor space completions then comprises training the machine learning model 209 using training data including an amount of example risk elements any other examples of risks/dangers to mobile systems 101 that is greater than a proportional amount (e.g., proportional amount occurring in historical observations).

As shown, the training module 205 can collect or otherwise access a database of risk/danger data 501 that records historical environment state or event data that are associated with risk or danger to mobile systems 101 operating in an environment 103. In one embodiment, the risk/danger data 501 include data records that record of environment states that have been labeled or otherwise associated with risky or dangerous events to mobile systems 101 including but not limited to accidents, “close shave” situations (e.g., near collisions, accidents, etc.), and/or other equivalent labels. For example, the environment states can include locations, heading, speed, etc. of objects in the environment 103 associated with potential risks or dangers to mobile systems 101. These situations can be either manually labeled (e.g., a human annotator) or machine labeled (e.g., by machine learning model trained to perform such classifications). These situations can be real-life observations or simulated situations (e.g., generated by other generative machine learning models, manually simulated, etc.). In addition or alternatively, the risk/danger situations or events can be associated with respective danger indices (e.g., risk scores computed based on the environment state that provides a numeric quantification of the potential risks or dangers). By way of example, the danger indices can be determined using a machine learning model trained to compute the danger index values (e.g., risk scores) based on features extracted from the environment state data.

In one embodiment, the risk/danger data 501 can refer to or be correlated with mobile sensor data 503 collected from mobile systems 101 (e.g., vehicles 105, robots 107, drones 109, etc.) involved in the corresponding risk/danger situations recorded in the risk/danger data 501. The mobile sensor data 503, for instance, can include the recorded trajectories (e.g., sampled locations over time) of the mobile systems 101 as they travel or operate within an environment. By way of example, the sensors data indicating the trajectories can include but are limited to video frames, geoposition tracks, LiDAR meshes, radar images, and/or other equivalent sensor data captured by one or more sensors 117 of a mobile system 101. The reference or correlation between the risk/danger data 501 and mobile sensor data 503 may associate the trajectory and/or particular mobile system 101 with a corresponding risk/danger situation recorded the risk/danger data 501. In other words, the training module 205 can match the situations of the risk/danger data 501 to individual trajectories recorded in the mobile sensor data 503 so that the trajectories are labeled with corresponding risks/dangers to generate labeled training data.

In one embodiment, this labeled training data (e.g., risk/danger data 501 correlated to respective trajectories of the mobile sensor data 503) optionally can be used to pre-train the generative/predictive model 209 (e.g., a conditional GAN that is to be trained to generate the sensor space completions). The pre-training enables the generative/predictive model 209 to learn a general correlation between mobile sensor data 503 and the risks or dangers that may be present in occluded sensor spaces within a model of the environment. However, as discussed above, risk or danger incidents are relatively sparse (e.g., occur relatively rarely) with to the lengths of the recorded trajectories or the total observed number of driving or operating situations/events involving mobile systems 101. Thus, the observed or actual proportion of a risk/danger situations to non-risk/danger situations will be relatively low.

To address this technical problem, in one embodiment, the training module 205 samples only dangerous or risky situations from the mobile sensor data 503 to create filtered mobile sensor data 505. In other words, the training module 205 aggregates example sensor data (e.g., mobile sensor data 503 to be used as training data) associated with a danger index value (e.g., risk score) above a threshold value to generate the training data stored in the filtered mobile sensor data 505. The danger index, for instance, is based on the one or more potential risks or dangers that are labeled in the example sensor data (e.g., based on a risk score computed based on risk factor elements detected in the sensor data).

As discussed above, the labeled sensor data that is to be used for training is labeled by correlating the risk/danger situations recorded in the risk/danger data 501 to the mobile sensor data 503). In one embodiment, to filter the sensor data 503, the training module 205 assumes that the risk/danger situation occurs at the end of most trajectories (e.g., because a trajectory may terminate at an accident location). Based on this assumption, the training module 205 can filter the mobile sensor data 503 by including only one or more immediate past over windows (e.g., predetermined time epochs such as the past 5 minutes, 10 minutes, etc.) of a trajectory in the filtered mobile sensor data 505. In other words, the example sensor data or training data (e.g., the filtered mobile sensor data 505) are taken from one or more final time windows associated with real or simulated scenarios involving the one or more potential risks.

In other embodiments, the risk/danger data 501 can include an attribute indicating the time frame over which the risk/danger is applicable. In this case, the training module 205 can use the applicable time frames indicated risk/danger data 501 to extract the corresponding trajectories from the same time frames to create the filtered mobile sensor data 505.

In either case, the resulting filtered mobile sensor data 505 will include a higher proportion of risk/danger examples than exists in the unfiltered mobile sensor data 503. In one embodiment, the filtered mobile sensor data 505 is used to train the generative/predictive model 209 to generate sensor space completions. This disproportionate amount of risk/danger examples in the training data (e.g., the filtered mobile sensor data 505) effectively biases the trained generative/predictive model to be more likely include risks/dangers in the generated sensor space completions when compared to conventional systems.

It is noted that the embodiments described above of generating training data that have a disproportionate amount of risk/danger are provided by way of example and not as limitations. It is contemplated that any means for resampling of the mobile sensor data 503 and/or risk/danger data 501 can be used to create the disproportionate filtered mobile sensor data 505.

In one embodiment, the training process includes extracting features from the filtered mobile sensor data 505 and correlated risk/danger data 501 to use for conditioning the generative/predictive model 209 (e.g., a conditional GAN). The trained generative/predictive model 209 can then generate predicted results 511 (e.g., sensor data completions for occluded sensor spaces) across a range of risk/danger classes (e.g., different types of accidents, collisions, damage, etc.) and/or related properties (e.g., damage potential, type of damage caused, etc.). because the generative/predicted model 209 was trained on data that includes a disproportionate amount of risk examples, the resulting sensor space completions will also be more biased towards how those potential risks present or originating from the corresponding occluded sensor space. In this way, the trained generative/predictive model 209 can provide for increased safety by causing mobile systems 101 to operate more cautiously as if risks/dangers are more likely to be present than observed in reality.

In one embodiment, the predicted results 511 (e.g., sensor space completions biased towards potential risks) can be generated based on inputs provided through interactions with the model-based control module 213 and/or mobile system 101. For example, the mobile system 101 (e.g., vehicle 105, robot 107, drone 109, etc.) can collect and provide to the generative/predictive model 209 (and/or any other component of the system 100) sensor data 513 as inputs to the model-based control module 213 and/or the generative/predictive model 209. By way of example, the sensor data 513 collected by mobile systems 101 is basically any composition of holistic sensor-feeds. The holistic sensor-feeds comprise one or more sensor data collected one or more different sensor types equipped in the mobile system including but not limited to sensor data from one or more of the following:
Camera;
LiDAR;
Radar;
Vehicle internal engine Revolutions Per Minute (RPMs), vehicle speed, control values typically read from a Controller Area Network (CAN)/On Board Diagnostics-II (OBD-II) bus or equivalent;
Satellite-based positioning (e.g., Global Positioning System (GPS)) or other positioning information.

It is noted that the examples of sensor data listed above are also applicable to sensor data stored in the mobile sensor data 503 and filtered mobile sensor data 505 components described above.

In one embodiment, the sensor data 513 is provided from the mobile system 101 to the model-based control module 213 to generate proposed actions 515 that the mobile system 101 can take in response to the environment state indicated in the sensor data 513. The model-based control module 213 provides the features extracted from the sensor data 513 as an input to a predictive control model 215 that has been trained to predict the proposed actions 515. These proposed actions 515 are operational actions that can be taken by the mobile system 101 such as but not limited to: (1) accelerating/decelerating; (2) taking a turn; (3) changing between autonomous, semi-autonomous, and manual driving modes; (4) calculating a new navigation route; (5) activating/deactivating sensors and/or safety systems; (6) presenting warning messages to drivers/passengers; and/or the like. In one embodiment, the proposed actions 515 can include multiple alternative actions that are candidates for controlling mobile system 101 before they are sent to the mobile system 101 to implement.

The model-based control module 213 can then provide the proposed actions 515 as an input to the generative/predictive model 209 that is configured to generated sensor space completions (e.g., the predicted results 511). In addition or alternatively, the sensor data 513 can be provided as an input to the generative/predictive model 209 without the proposed actions 515 of the model-based control module 213.

On receiving the sensor data 513 of the mobile system 101 and/or the proposed actions 515 of the model-based control module 213, the generative/predictive model 209 can generate the sensor space completions for any occluded sensor space in the environment 103 in which the mobile system 101 is operating. For example, input features from the sensor data 513 and/or proposed actions 515 are extracted and provided (e.g., in vector form) to the generative/predictive model 209 to generate sensor space completions that are biased towards including risks/dangers to the mobile system 101. As shown in step 305 of the process 300, the output module 207 can then provide the predicted results 511 (e.g., sensor space completions) to a system (e.g., the model-based control module 213 of the control module 111 and/or control platform 113) of the mobile system 101 (e.g., vehicle 105, robot 107, drone 109, etc.) for generating a control decision, a warning, or a combination thereof.

In one embodiment, the model-based control module 213 uses the predicted results 511 (e.g., sensor space completions biased towards risks/dangers) as an input to the predictive control model 215 to generate the control decisions (e.g., control actions 517) and/or warning messages indicating the potential risks/dangers. Similar to the proposed actions 515, the control actions 517 are operational actions that can be taken by the mobile system 101 such as but not limited to: (1) accelerating/decelerating; (2) taking a turn; (3) changing between autonomous, semi-autonomous, and manual driving modes; (4) calculating a new navigation route; (5) activating/deactivating sensors and/or safety systems; (6) presenting warning messages to drivers/passengers; and/or the like. Unlike proposed actions 515, however, the control actions 517 are transmitted as control decisions that are to be implemented by the mobile system 101.

FIG. 5B describes a second training option and is a flowchart of a process or training a machine learning model (e.g., generative/predictive model 209) using a risk score, according to an example embodiment. In contrast to the training option of FIG. 5A, the various embodiments of FIG. 5B generates sensor space completions using a machine learning model (e.g., generative/predictive model 209) in which the biasing of the generation of one or more potential risks (e.g., that are included in the sensor space completions) comprises providing a risk score/danger index of the one or more potential risks originating from the occluded space as an input to the machine learning model. With respect to training, the machine learning model is a generative model (e.g., conditional GAN), and the input of the risk score/danger index is a conditional input to the generative model to learn and associate the risk score to a situation associated with the sensor data. For example, the generative model is configured to give a high target value to the sensor data associated a risk score/danger index that is over a threshold risk level.

As in the example of FIG. 5A, the example of FIG. 5B includes collecting or otherwise accessing a database of risk/danger data 501 that records historical environment state or event data that are associated with risk or danger to mobile systems 101 operating in an environment 103. In this embodiment, the risk/danger situations or events are associated with respective danger indices (e.g., risk scores computed based on the environment state that provides a numeric quantification of the potential risks or dangers). To generate the danger indices/risk scores, the training module 205 can initiate a pre-training of an optional generative/predictive model 521 (or any other machine learning model including the generative/predictive model 209 itself) to predict the danger index value or risk score for risk/danger events stored in the risk/danger data 501.

The optional generative/predictive model 521 can be trained to predict risk scores using the risk/danger data 501 as training data. For example, the training data can include but is not limited to labeling of example environment states or events with corresponding ground truth danger indices/risk scores. It is contemplated that the danger indices/risk scores can be represented using any metric, value range, and/or the like. For example, a continuous value range of between 0 and 1 can be used to indicate minimum or no risk/danger at 0 and maximum risk at 1. Then as new risk/danger data is collected, the optional generative/predictive model 521 can be used to predict corresponding danger indices/risk scores to populate the risk/danger data 501.

In one embodiment, the risk/danger data 501 can refer to or otherwise be correlated with mobile sensor data 503 (e.g., as described with respect to FIG. 5A). In this case, the optional generative/predictive model 521 can be trained to predict the danger indices/risk scores using the mobile sensor data 503 alone or in combination with the risk/danger data 501. As additional sensor data 513 is collected from the mobile systems 101, the sensor data 513 can be evaluated and scored by the optional generative/predictive model 521 to predict respective danger indices/risk scores for the new sensor data 513. The training module 205 can then use the predicted danger indices/risk scores to automatically collect incremental accident, “close shave,” or any other risk/danger event by comparing the predicted danger indices/risk scores to respective risk threshold levels or criteria.

In one embodiment, the training module 205 can use the risk/danger data 501 (e.g., including risk data generated based on the danger indices/risk scores predicted by the optional generative/predictive model 521) to condition the generative/predictive model 209 (e.g., conditional GAN) to predict sensor space completions that bias towards including potential risks originating from the completions. For example, the conditioning comprises providing examples of risk/danger classes and their related properties that are to be included in the sensor space completions. The training module 205 can also use, for instance, time set-value conditioning or equivalent of the generative/predictive model 209 (e.g., generator and/or discriminator networks of the model 209) to set a danger value to a specific value. The specific value can be determined based on a target level of biasing that is to be performed during sensor space completion. For example, if risks/dangers are biased more heavily, then the risks/dangers in the sensor space completions will also be increased, thereby causing more cautious control actions 517 to be generated for the mobile systems 101 operating in corresponding environments 103. In this way, the generative/predictive model 209 can be trained to predict sensor completions that contain risks/dangers at the specific danger/risk value without having to resample or bias the training data as discussed in the training option of FIG. 5A.

The conditioned and trained generative/predictive model 209 can then be used to generate predicted results 511 (e.g., sensor space completions biased towards potential risks) as described with respect to FIG. 5A. For example, mobile systems 101 can collect new sensor data 513 for the model-based control module 213 generate proposed actions 515 that can be taken by the mobile systems. The sensor data 513 and/or proposed actions 515 can be used as input features for the trained generative/predictive model 209 to generate the predicted results 511 (e.g., sensor space completions biased towards potential risks). The model-based control module 213 can use the predicted results 511 to determine the control actions 517 (or warnings of potential risks/dangers) that are sent to the mobile systems 101).

In one embodiment, the new sensor data 513 collected by the mobile systems 101 can also be transmitted for evaluation by the optional generative/predictive model 521 to predict respective danger indices/risk scores. The new sensor data 513 and associated danger indices/risk scores can be used to incrementally update the mobile sensor data 503 and/or risk/danger data 501. In other words, under this embodiment, it is also separately possible to train the optional generative/predictive model 521 which learns to predict risk scores of eventualities for the purposes of either closing the loop on sensor data collection or creating real-time automated warnings. Danger-indexed data (e.g., risk/danger data 501) can be collected by manual labelling or by various fully or partially automated methods for example by taking final time windows from real or simulated accident scenarios (e.g., recorded in mobile sensor data 503). The danger index conditioned generative model 209 (which can be, e.g., a conditional GAN, a recurrent model, an auto-encoder, a predictive supervised model, or equivalent) can also produce data for augmenting the training of the optional danger index predicting model 521.

In summary, as described with respect to FIG. 5A, the output module 207 provides the sensor space completion (e.g., predicted results 511) to a system (e.g., model-based control module 213) of a mobile system 101 (e.g., vehicle 105, robot 107, drone 109, etc.) for generating a control decision (e.g., control action 517), a warning, or a combination thereof (in step 305 of the process 300). In one embodiment, at least one component or sub-system of the mobile system 101 includes a model-based system (e.g., the model-based control module 213) for generating control decisions, warnings, or a combination thereof based on the state of the environment 103 in which the mobile system 101 is operating. For example, the vehicle 105, robot 107, drone 10 and/or any other equivalent mobile system 101 can support autonomous operation. Thus, the control decision, the warning, or a combination thereof relates to the autonomous operation of the mobile system 101.

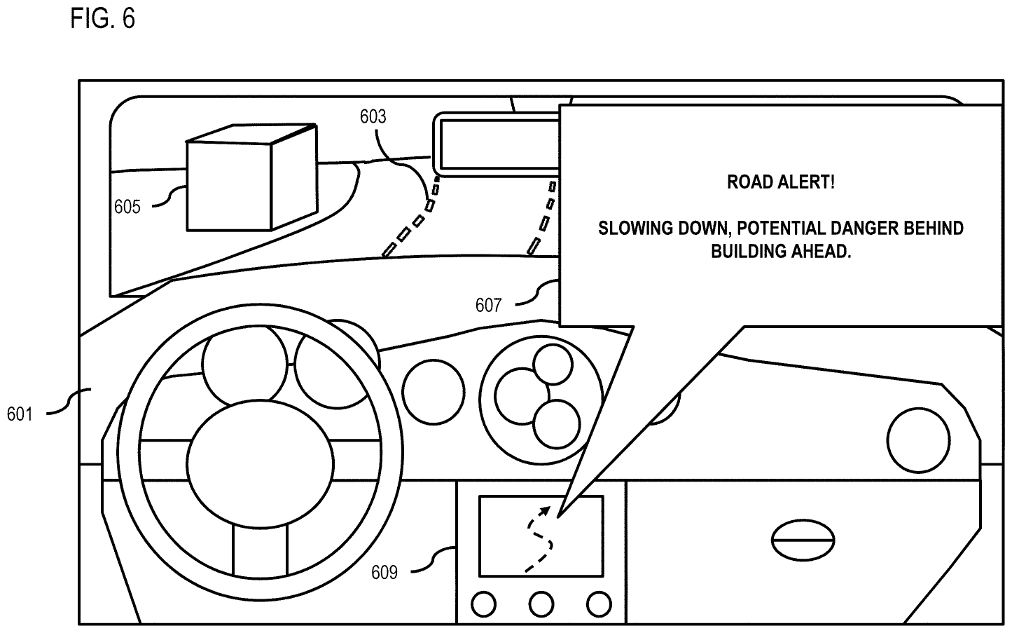

FIG. 6 is a diagram illustrating an example of making a vehicle control decision and generating a warning message based on a machine learning model biased toward potential risk, according to an example embodiment. In the example of FIG. 6, an autonomous vehicle 601 is driving on a road 603 with a building 605 obstructing the sensor data coverage for the volumetric space behind the building 605 and creating a sensor space occlusion. For example, the autonomous vehicle 601's camera and LiDAR sensors do not have any sensor data to indicate what, if any, dangers exist behind the building 605. The vehicle 601 is equipped with a control module 111 coupled with a generative/prediction model 209 to perform sensor space completions that are biased towards potential risks according to the embodiments described herein.

Accordingly, the available sensor data captured of the driving environment and proposed actions by the vehicle 601 (e.g., drive past the building 605 at a certain speed) are provided as inputs to the generative/predictive model 209. The model 209 generates a sensor space completion that is biased to indicate that a potential danger exists from an animal being present behind the building and has a trajectory that will enter the roadway in front of the vehicle 601 for a potential collision. In response to this prediction, the control module 111 generates a control decision to automatically slow down the vehicle as it drives past the building 605 to reduce the chance of damage to the vehicle 601 if it should encounter the predicted danger. In addition, a warning message 607 is presented via user interface 609 of a vehicle navigation system to inform the passengers of a “Road Alert!” and indicating that the vehicle 601 is “Slowing down” because of a “Potential danger behind building ahead.”

Returning to FIG. 1, as shown, the system 100 comprises at least one mobile system 101 (e.g., vehicle 105, robot 107, drone 109, and/or the like) equipped with a variety of sensors 117. In one embodiment, the system 100 further includes the control module 111 and/or control platform 113 for autonomous or semi-autonomous control the mobile systems based on sensor space completions as discussed with respect to the various embodiments described herein. By way example, the sensors 117 may include, but are not limited to, a global positioning system (GPS) sensor for gathering location data based on signals from a satellite, inertial sensors, Light Detection And Ranging (Lidar) for gathering distance data and/or generating depth maps, Radio Detection and Ranging (Radar), wireless network detection sensors for detecting wireless signals or receivers for different short-range communications (e.g., Bluetooth®, Wireless Fidelity (Wi-Fi), Li-Fi, Near Field Communication (NFC), etc.), temporal information sensors, a camera/imaging sensor for gathering image data, and the like. The mobile systems 101 may also include recording devices for recording, storing, and/or streaming sensor and/or other telemetry data to the control module 111, control platform 113, and/or any other component of the system 100.

In one embodiment, the mobile system 101 (e.g., a vehicle 105) is an autonomous, semi-autonomous, or highly assisted driving vehicle that is capable of sensing its environment and navigating within a travel network without driver or occupant input using a variety of sensors 117. It is noted that autonomous vehicles 105 and/or any other mobile system are part of a spectrum of vehicle classifications that can span from no automation to fully autonomous operation. For example, the U.S. National Highway Traffic Safety Administration (“NHTSA”) in its “Preliminary Statement of Policy Concerning Automated Vehicles,” published 2013, defines five levels of vehicle automation:

Level 0 (No-Automation)—“The driver is in complete and sole control of the primary vehicle controls—brake, steering, throttle, and motive power—at all times.”;

Level 1 (Function-specific Automation)—“Automation at this level involves one or more specific control functions. Examples include electronic stability control or pre-charged brakes, where the vehicle automatically assists with braking to enable the driver to regain control of the vehicle or stop faster than possible by acting alone.”;

Level 2 (Combined Function Automation)—“This level involves automation of at least two primary control functions designed to work in unison to relieve the driver of control of those functions. An example of combined functions enabling a Level 2 system is adaptive cruise control in combination with lane centering.”;

Level 3 (Limited Self-Driving Automation)—“Vehicles at this level of automation enable the driver to cede full control of all safety-critical functions under certain traffic or environmental conditions and in those conditions to rely heavily on the vehicle to monitor for changes in those conditions requiring transition back to driver control. The driver is expected to be available for occasional control, but with sufficiently comfortable transition time.”; and

Level 4 (Full Self-Driving Automation)—“The vehicle is designed to perform all safety-critical driving functions and monitor roadway conditions for an entire trip. Such a design anticipates that the driver will provide destination or navigation input but is not expected to be available for control at any time during the trip. This includes both occupied and unoccupied vehicles.”

In one embodiment, the various embodiments described herein are applicable to autonomous mobile systems 101 that are classified in any of the levels of automation (levels 0-4) discussed above, provided that they are equipped with sensors 117 that support autonomous operation. By way of example, the sensors 117 may any vehicle sensor known in the art including, but not limited to, a Lidar sensor, Radar sensor, infrared sensor, global positioning sensor for gathering location data (e.g., GPS), inertial measurement unit (IMU), network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data about a roadway, an audio recorder for gathering audio data, velocity sensors mounted on steering wheels of the vehicles, vehicle-to-vehicle communication devices or sensors, switch sensors for determining whether one or more vehicle switches are engaged, and the like.

Other examples of the sensors 117 may include light sensors, orientation sensors augmented with height sensors and acceleration sensor (e.g., an accelerometer can measure acceleration and can be used to determine orientation of the vehicle), tilt sensors to detect the degree of incline or decline (e.g., slope) of the vehicle along a path of travel, moisture sensors, pressure sensors, etc. In a further example embodiment, sensors about the perimeter of the mobile system 101 may detect the relative distance of the vehicle from a lane or roadway, the presence of other vehicles, pedestrians, traffic lights, potholes and any other objects, or a combination thereof. In one scenario, the sensors may detect weather data, traffic information, or a combination thereof. In yet another embodiment, the sensors can determine the status of various control elements of the car, such as activation of wipers, use of a brake pedal, use of an acceleration pedal, angle of the steering wheel, activation of hazard lights, activation of head lights, etc. In one embodiment, the sensor data can be collected by and/or retrieved from an on-board diagnostic (OBD) or other vehicle telemetry system of the mobile system 101 through an interface or port (e.g., an OBD II interface or equivalent).

By way of example, the control module 111 and/or control platform 113 is any type of dedicated vehicle control unit, mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that control module 111 and/or control platform 113 can support any type of interface to the user (such as “wearable” circuitry, etc.). In addition, the control module 111 and/or control platform 113 may facilitate various input means for receiving and generating information, including, but not restricted to, a touch screen capability, a keyboard and keypad data entry, a voice-based input mechanism, and the like.

In one embodiment, the communication network 119 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

In one embodiment, the control module 111 and/or control platform 113 can interact with the services platform 123 to receive data for configuring machine learning models to bias sensor space completions towards potential risks/dangers. By way of example, the services platform 123 may include one or more services 125a-125n for providing data used by the system 100, as well as providing related services such as provisioning services, application services, storage services, mapping services, navigation services, contextual information determination services, location-based services, information-based services (e.g., weather), etc. In one embodiment, the services platform 123 may include or be associated with the geographic database 121.

By way of example, the mobile systems 101, control module 111, control platform 113, and/or any other component of the system 100 communicate with each other using well known, new or still developing protocols. In this context, a protocol includes a set of rules defining how the network nodes within the communication network 119 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes may be effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

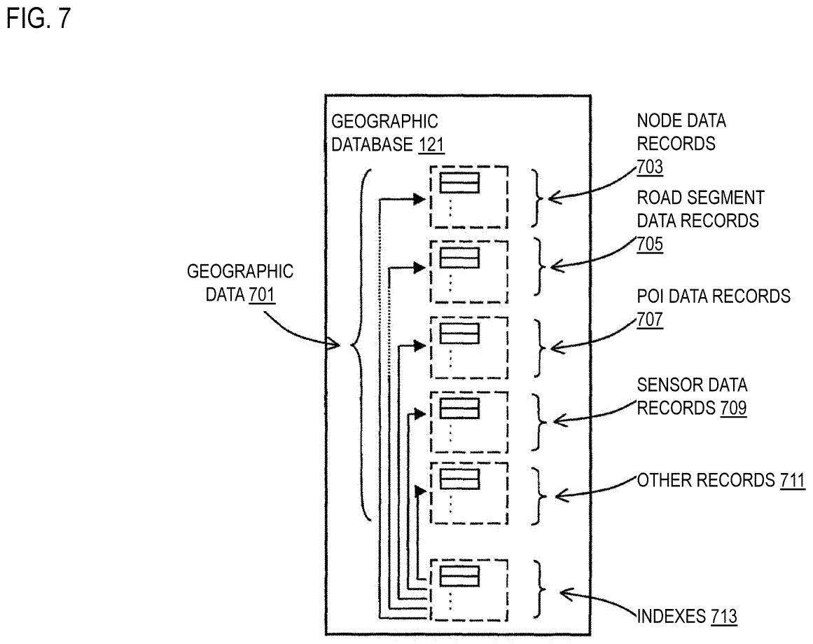

FIG. 7 is a diagram of a geographic database including map data for planning a route of the drone 109, according to one embodiment. In one embodiment, the geographic database 121 includes geographic data 701 used for (or configured to be compiled to be used for) mapping and/or navigation-related services. In one embodiment, a computed route (e.g., a 3D flightpath for an aerial drone 109a or route for non-aerial drone 109b) is executed by a drone 109 for performing inspection and/or interaction functions on the mobile system 101 and/or its sensors 117 or other parts.

In one embodiment, geographic features (e.g., two-dimensional or three-dimensional features) are represented in the geographic database 121 using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions, models, routes, etc. Accordingly, the terms polygons and polygon extrusions/models as used herein can be used interchangeably.

In one embodiment, the following terminology applies to the representation of geographic features in the geographic database 121.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 121 follows certain conventions. For example, links do not cross themselves and do not cross each other except at a node. Also, there are no duplicated shape points, nodes, or links. Two links that connect each other have a common node. In the geographic database 121, overlapping geographic features are represented by overlapping polygons. When polygons overlap, the boundary of one polygon crosses the boundary of the other polygon. In the geographic database 121, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic data 701 of the database 121 includes node data records 703, road segment or link data records 705, POI data records 707, sensor data records 709, other data records 711, and indexes 713, for example. More, fewer or different data records can be provided. In one embodiment, additional data records (not shown) can include cartographic (“carto”) data records, routing data, and maneuver data. In one embodiment, the indexes 713 may improve the speed of data retrieval operations in the geographic database 121. In one embodiment, the indexes 713 may be used to quickly locate data without having to search every row in the geographic database 121 every time it is accessed. For example, in one embodiment, the indexes 713 can be a spatial index of the polygon points associated with stored feature polygons.

In exemplary embodiments, the road segment data records 705 are links or segments representing roads, streets, or paths, as can be used in the calculated route or recorded route information for determination of one or more personalized routes. The node data records 703 are end points corresponding to the respective links or segments of the road segment data records 705. The road link data records 705 and the node data records 703 represent a road network, such as used by vehicles, cars, and/or other entities. In addition, the geographic database 121 can contain path segment and node data records or other data that represent 3D paths around 3D map features (e.g., terrain features, buildings, other structures, etc.) that occur above street level, such as when routing or representing flightpaths of aerial vehicles (e.g., aerial drone 109a), for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 121 can include data about the POIs and their respective locations in the POI data records 707. The geographic database 121 can also include data about places, such as cities, towns, or other communities, and other geographic features, such as bodies of water, mountain ranges, etc. Such place or feature data can be part of the POI data records 707 or can be associated with POIs or POI data records 707 (such as a data point used for displaying or representing a position of a city).

In one embodiment, the geographic database 121 can also include sensor data records 709 for storing sensor data, risk/danger data, machine learning models 115, and/or related information for biasing machine learning models towards potential risks according to the embodiments described herein.

In one embodiment, the geographic database 121 can be maintained by the services platform 123 and/or any of the services 125 of the services platform 123 (e.g., a map developer). The map developer can collect geographic data to generate and enhance the geographic database 121. There can be different ways used by the map developer to collect data. These ways can include obtaining data from other sources, such as municipalities or respective geographic authorities. In addition, the map developer can employ aerial drones (e.g., using the embodiments of the privacy-routing process described herein) or field vehicles (e.g., mapping drones or vehicles equipped with mapping sensor arrays, e.g., Lidar) to travel along roads and/or within buildings/structures throughout the geographic region to observe features and/or record information about them, for example. Also, remote sensing, such as aerial or satellite photography or other sensor data, can be used.

The geographic database 121 can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation capable device or vehicle, such as by the drone 109 and/or the mobile system 101, for example. The navigation-related functions can correspond to 3D flightpath or navigation, e.g., 3D route planning for drone navigation. The compilation to produce the end user databases can be performed by a party or entity separate from the map developer. For example, a customer of the map developer, such as a navigation device developer, automobile manufacturer, original equipment manufacturer, or other end user device developer, can perform compilation on a received geographic database in a delivery format to produce one or more compiled navigation databases.

The processes described herein for biasing machine learning models towards potential risks/dangers may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

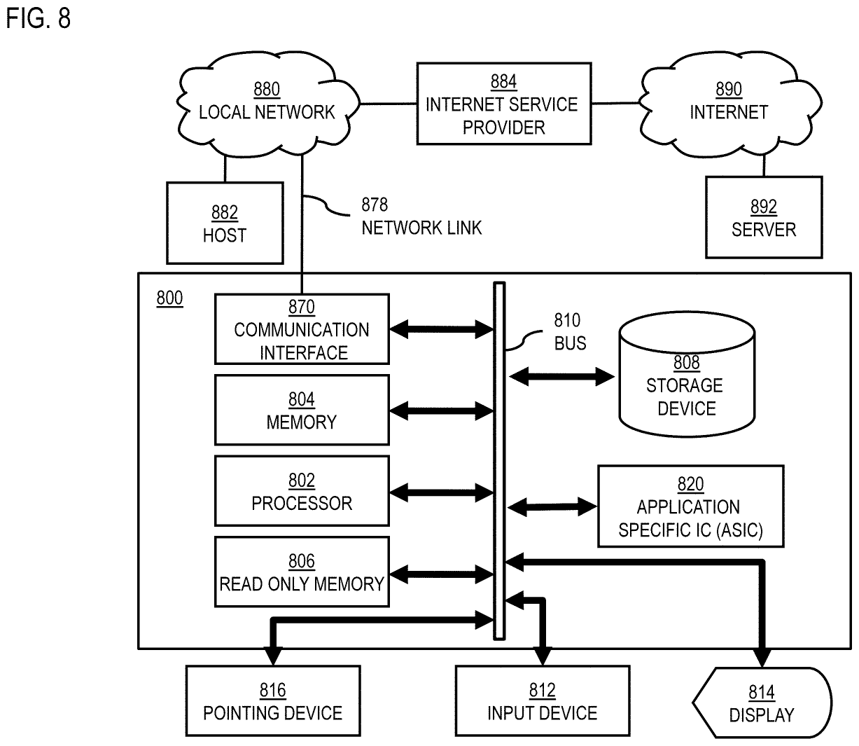

FIG. 8 illustrates a computer system 800 upon which an embodiment of the invention may be implemented. Computer system 800 is programmed (e.g., via computer program code or instructions) to bias machine learning models towards potential risks/dangers as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 810 includes one or more parallel conductors of information so that information is transferred quickly among devices coupled to the bus 810. One or more processors 802 for processing information are coupled with the bus 810.

A processor 802 performs a set of operations on information as specified by computer program code related to biasing machine learning models towards potential risks/dangers. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or other dynamic storage device, stores information including processor instructions for biasing machine learning models towards potential risks/dangers. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for biasing machine learning models towards potential risks/dangers, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT) or a liquid crystal display (LCD), or plasma screen or printer for presenting text or images, and a pointing device 816, such as a mouse or a trackball or cursor direction keys, or motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of application specific ICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 117 for biasing machine learning models towards potential risks/dangers.

The term computer-readable medium is used herein to refer to any medium that participates in providing information to processor 802, including instructions for execution. Such a medium may take many forms, including, but not limited to, non-volatile media, volatile media and transmission media. Non-volatile media include, for example, optical or magnetic disks, such as storage device 808. Volatile media include, for example, dynamic memory 804. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system can be deployed in various configurations within other computer systems, e.g., host 882 and server 892.

FIG. 9 illustrates a chip set 900 upon which an embodiment of the invention may be implemented. Chip set 900 is programmed to bias machine learning models towards potential risks/dangers as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to bias machine learning models towards potential risks/dangers. The memory 905 also stores the data associated with or generated by the execution of the inventive steps.

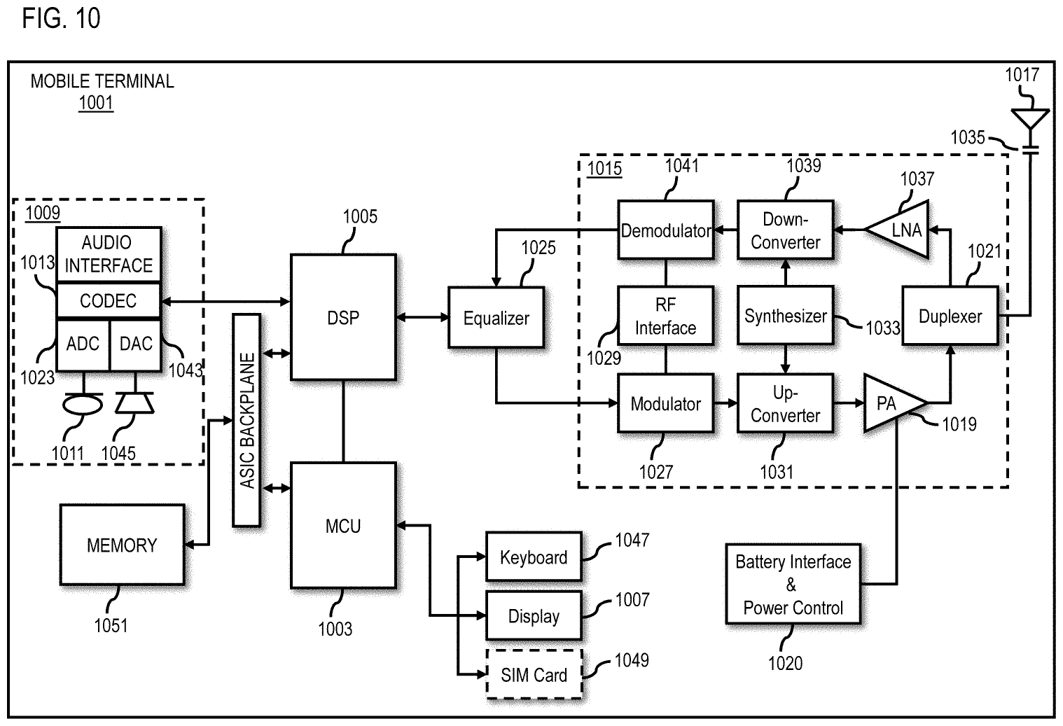

FIG. 10 is a diagram of exemplary components of a mobile terminal (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile station functions that offer automatic contact matching. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile station 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, 5G New Radio networks, code division multiple access (CDMA), wireless fidelity (WiFi), satellite, and the like.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003—which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile station 1001 to bias machine learning models towards potential risks/dangers. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the station. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile station 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1051 may be, but not limited to, a single memory, CD, DVD, ROM, RAM, EEPROM, optical storage, or any other non-volatile or non-transitory storage medium capable of storing digital data.

An optionally incorporated SIM card 1049 carries, for instance, important information, such as the cellular phone number, the carrier supplying service, subscription details, and security information. The SIM card 1049 serves primarily to identify the mobile station 1001 on a radio network. The card 1049 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
determining an occluded space that is occluded in sensor data collected from one or more sensors of a vehicle or a robot;
generating a sensor space completion that represents the occluded space based on biasing a generation of one or more potential risks to the vehicle or the robot originating from the occluded space; and
providing the sensor space completion to a system of the vehicle or the robot for generating a control decision, a warning, or a combination thereof.

2. The method of claim 1, wherein the sensor space completion is generated using a machine learning model, and wherein the biasing of the generation of the one or more potential risks comprises training the machine learning model using training data including an amount of example risk elements greater than a proportional amount.

3. The method of claim 2, further comprising:
aggregating example sensor data associated with a danger index value above a threshold value to generate the training data,
wherein the danger index is based on the one or more potential risks that are labeled in the example sensor data.

4. The method of claim 3, further comprising:
initiating a pre-training of the machine learning model to predict the danger index value.

5. The method of claim 3, wherein the example sensor data are taken from one or more final time windows associated with real or simulated scenarios involving the one or more potential risks.

6. The method of claim 1, wherein the sensor space completion is generated using a machine learning model, and wherein the biasing of the generation of the one or more potential risks comprises providing a risk score of the one or more potential risks originating from the occluded space as an input to the machine learning model.

7. The method of claim 6, wherein the machine learning model is a generative model, and wherein the input is a conditional input to the generative model to learn and associate the risk score to a situation associated with the sensor data.

8. The method of claim 7, wherein the generative model is configured to give a high target value to the sensor data associated the risk score that is over a threshold risk level.

9. The method of claim 1, wherein the system of the vehicle or the robot includes a machine learning model-based system for generating the control decision, the warning, or a combination thereof.

10. The method of claim 1, wherein the vehicle, the robot, or a combination thereof supports autonomous operation; and wherein the control decision, the warning, or a combination thereof relates to the autonomous operation.

11. An apparatus comprising:
at least one processor; and
at least one memory including computer program code for one or more programs,
the at least one memory and the computer program code configured to, with the at least one processor, cause the apparatus to perform at least the following,
determine an occluded space that is occluded in sensor data collected from one or more sensors of a vehicle or a robot;
generate a sensor space completion that represents the occluded space based on biasing a generation of one or more potential risks to the vehicle or the robot originating from the occluded space; and
provide the sensor space completion to a system of the vehicle or the robot for generating a control decision, a warning, or a combination thereof.

12. The apparatus of claim 11, wherein the sensor space completion is generated using a machine learning model, and wherein the biasing of the generation of the one or more potential risks comprises training the machine learning model using training data including an amount of example risk elements greater than a proportional amount.

13. The apparatus of claim 12, wherein the apparatus is further caused to:
aggregate example sensor data associated with a danger index value above a threshold value to generate the training data,
wherein the danger index is based on the one or more potential risks that are labeled in the example sensor data.

14. The apparatus of claim 13, wherein the apparatus is further caused to:
initiate a pre-training of the machine learning model to predict the danger index value.

15. The apparatus of claim 11, wherein the sensor space completion is generated using a machine learning model, and wherein the biasing of the generation of the one or more potential risks comprises providing a risk score the one or more potential risks originating from the occluded space as an input to the machine learning model.

16. A non-transitory computer-readable storage medium, carrying one or more sequences of one or more instructions which, when executed by one or more processors, cause an apparatus to perform:
determining an occluded space that is occluded in sensor data collected from one or more sensors of a vehicle or a robot;
generating a sensor space completion that represents the occluded space based on biasing a generation of one or more potential risks to the vehicle or the robot originating from the occluded space; and
providing the sensor space completion to a system of the vehicle or the robot for generating a control decision, a warning, or a combination thereof.

17. The non-transitory computer-readable storage medium of claim 16, wherein the sensor space completion is generated using a machine learning model, and wherein the biasing of the generation of the one or more potential risks comprises training the machine learning model using training data including an amount of example risk elements greater than a proportional amount.

18. The non-transitory computer-readable storage medium of claim 16, wherein the sensor space completion is generated using a machine learning model, and wherein the biasing of the generation of the one or more potential risks comprises providing a risk score the one or more potential risks originating from the occluded space as an input to the machine learning model.

19. The non-transitory computer-readable storage medium of claim 18, wherein the machine learning model is a generative model, and wherein the input is a conditional input to the generative model to learn and associate the risk score to a situation associated with the sensor data.

20. The non-transitory computer-readable storage medium of claim 19, wherein the generative model is configured to give a high target value to the sensor data associated the risk score that is over a threshold risk level.
